(19) United States
(12) Patent Application Publication
(10) Pub. No.: US 2015/0120950 A1
(43) Pub. Date: Apr. 30, 2015

(54) Portable Short-Range Input Device

(71) Applicant: Shashidhar Ramareddy, Bangalore (IN)

(72) Inventor: Shashidhar Ramareddy, Bangalore (IN)

(21) Appl. No.: 14/068,685

(22) Filed: Oct. 31, 2013

(51) Int. Cl. H04L 29/08; H04W 4/00

(52) U.S. Cl. CPC H04L 67/141; H04W 4/008
USPC 709/229

(57) ABSTRACT

Techniques for sharing a shared resource. A connection is established between a sharing control device and a shared resource to control sharing of the shared resource with one or more source devices. The sharing control device is external from the shared resource and the one or more source devices. A data transfer is initiated between the sharing control device and the shared resource. Control of the shared resource is granted to a selected source device from the one or more source devices in response to the sharing control device granting control of the shared resource to the selected source device.

### TECHNICAL FIELD

Embodiments of the invention relate to input devices. More particularly, embodiments of the invention relate to wireless input devices.

### BACKGROUND

Current input and/or control devices tend to be either wired (e.g., Universal Serial Bus, USB, IEEE 1394, serial ports) or wireless (e.g., Bluetooth, ZigBee, NFC). Wired connections typically assume a longer connection, while wired connections do not necessarily assume the longer connection. However, these connection mechanisms are designed for certain types of settings and/or connection types and may not be optimal for other types of settings and/or connection types.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a system in which a control device can be used to coordinate sharing of a shared resource.

FIG. 2 is a flow diagram of one embodiment of a technique for controlling access to a shared resource using a sharing control device.

FIG. 3 is a block diagram of one embodiment of an electronic system.

FIG. 4 is a block diagram of one embodiment of an agent that may be utilized to support sharing control functionality.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

As described herein devices (e.g., input devices, peripheral devices) that require only a relatively short connection and/or a relatively light data transfer requirement, may be better suited utilizing the techniques described herein as compared to previous standards. For example, in a classroom where a teacher wishes to project a student's laptop screen using a shared projector. Traditional techniques require that 1) the student connect the laptop to the projector explicitly, either via wired or wireless connection; and 2) the teacher (or other entity) authorize the student to use the projector. This is not a seamless and/or intuitive process.

The techniques described herein provide a more seamless and elegant mechanism for the student's laptop screen to be projected. Returning to the classroom example, the teacher may hold a handheld device (called the “magic wand” in this example) that allows the teacher to touch (or come close to) the laptop to pair the laptop wirelessly with the projector. When the teacher wishes to share another student's laptop, the teacher touches (or comes close to) the next laptop to be shared, which is automatically paired with the shared projector. This sort of sharing/pairing can be utilized in many settings.

In one embodiment, the device (i.e., the magic wand) need not be connected (either wirelessly or via wired connection) very long and can be easily retrieved by the person directing the connections. In addition to classroom settings, the techniques and mechanisms described herein may be useful in, for example, a conference setting, an information kiosk, in a situation where a stream of mobile devices (e.g., laptops, smart phones, tables, automobiles) communicate with a shared device. These are merely a few examples and should not be considered limiting.

In various embodiments, the magic wand device provides one or more of: 1) connection/proximity sensing without firmly lodging the magic wand with the other device(s); 2) relatively fast device recognition; 3) short data transfer bursts; and/or 4) quick disconnect.

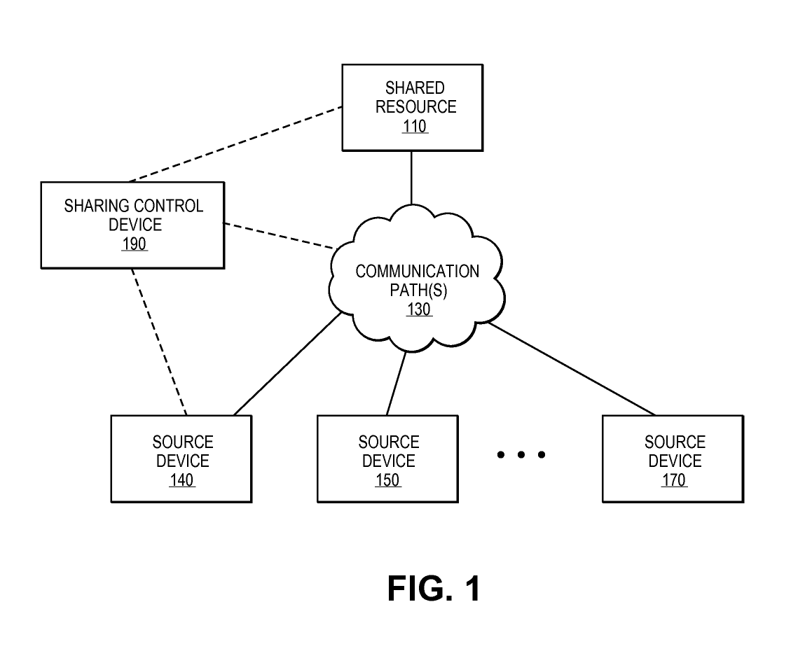

FIG. 1 is a block diagram of one embodiment of a system in which a sharing control device can be used to coordinate sharing of a shared resource either in exclusive mode (Complete ownership) or shared mode (shared ownership). The example of FIG. 1 is a classroom-type setting where a shared resource (e.g., a printer, a projector) can be shared by multiple source devices (e.g., laptop computers, tablets, smart phones, remote controls).

Shared resource 110 can be any type of resource that can be shared. For example, shared resource 100 can be a printer, a projector, a storage device, a display device, an optical device, an audio device, or any other type of device. Source devices 140, 150 and 170 can be any type of device that can interact with shared resource 110. For example, the source devices can be laptop computers, tablets, microphones, storage devices, smart phones, eye tracking devices, or any other type of device.

Communication path(s) 130 represents any type of communication, whether wired or wireless, between shared resource 110 and source devices 140, 150 and 170. While only three source devices are illustrated in FIG. 1, any number of source devices can be supported using the techniques and mechanisms described herein. Communication path(s) 130 can be, for example, an IEEE 802-based network, a Bluetooth link, a Zigbee link, a Near Field Control link, an infrared link and/or any other type of communications link.

Sharing control device 190 can communicate with shared resource 110 directly (e.g., Bluetooth, Zigbee, NFC) and/or though communication path(s) 130. Similarly, sharing control device 190 can communicate with source devices 140, 150 and 170 directly (e.g., Bluetooth, Zigbee, NFC) and/or through communication path(s) 130.

Continuing the classroom example above, a teacher may hold (or wear or carry) sharing control device 190, which can be used to control access to shared resource 100. For example, shared resource 110 can be a projector coupled with a wireless local area network (LAN). Source devices 140, 150 and 170 may also be coupled with the wireless LAN, but may only have authority to access shared resource 110 when granted by sharing control device 190.

Thus, each student in a classroom can have a computing device (e.g., laptop, tablet, smartphone) with a presentation or other information that can be shared in turn as controlled by a teacher with sharing control device 190. For example, multiple students may give presentations during a class period and the presentations may occur when the teacher grants access to the projector using the sharing control device (magic wand).

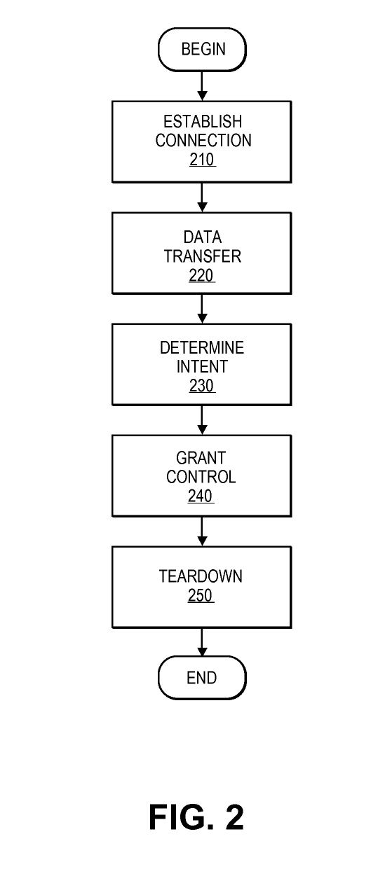

FIG. 2 is a flow diagram of one embodiment of a technique for controlling access to a shared resource using a sharing control device. The operation described with respect to FIG. 2 can be performed within the system illustrated in FIG. 1.

A connection is established between the sharing control device and a shared resource/source device, 210. In one embodiment, as the sharing control device completes a connection with the shared resource, a cue (e.g., visual, audio and/or tactile) is generated to let the user know that a connection has been established. The connection can be either wired or wireless. For example, the connection can be made via Bluetooth protocols, Zigbee, NFC, RFID or any other short-range wireless connection. Alternatively, some physical connection can be made.

A data transfer between the source device and the shared resource is initiated, 220. In one embodiment, the source device identifies the sharing control device via the connection (210) and initiates a burst data transfer to the sharing control device. Any appropriate data transfer protocol can be used.

Data interpretation based on perceived user intent is performed, 230. In one embodiment, based on the type content to be transferred, either secure or unsecure communications can be chosen. In one embodiment, an entry is added to the shared resource if the sharing control device is to be used with the shared resource as a target device. In one embodiment, the time of expiry of current session is communicated to the client. Other intent and/or information such as cleanup actions on connection teardown, available alternate communication techniques, available devices and capabilities etc., could be communicated. This entry can be permanent or can have an expiration.

In one embodiment, if the sharing control device is brought near the display (i.e., to cause another connection) after a connection with a source device, the shared resource is likely to be a target of sharing and wireless paring is triggered by the shared resource and/or the source device. In one embodiment, control of the shared resource can be granted, either temporarily or until further action by the sharing control device, to the source device to utilize the shared resource, 240.

Connection teardown, 250, can occur when sharing is completed. A cue is generated informing user of sharing process completion so that sharing control device could be safely retrieved. This process could either initiated post connection establishment with shared device or post data transfer or premature retrieval of sharing control device.

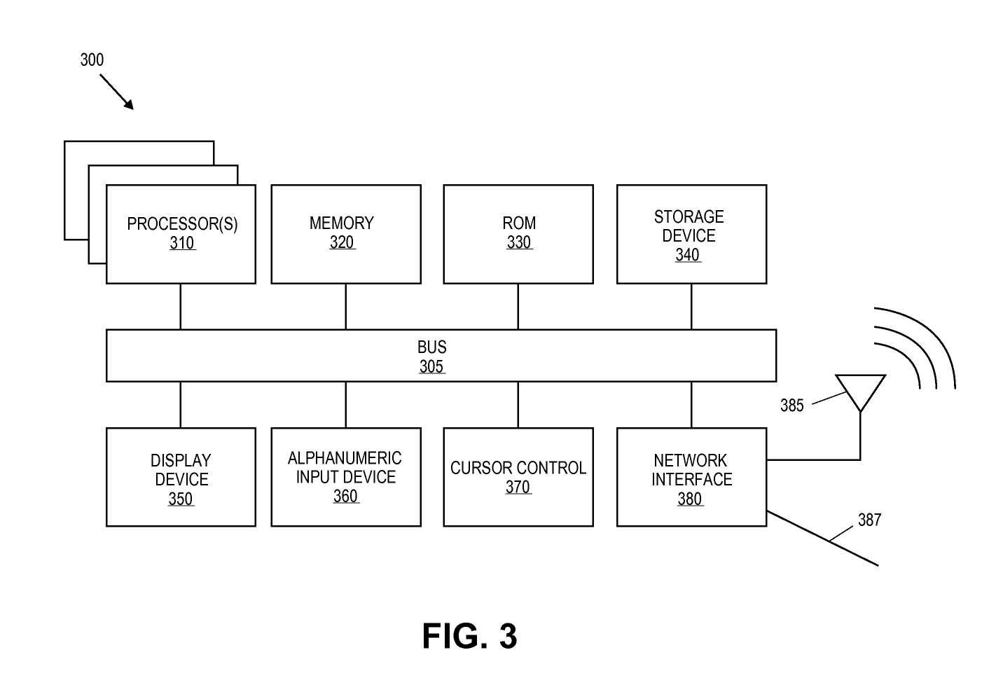

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes, tablets, etc. Alternative electronic systems may include more, fewer and/or different components.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

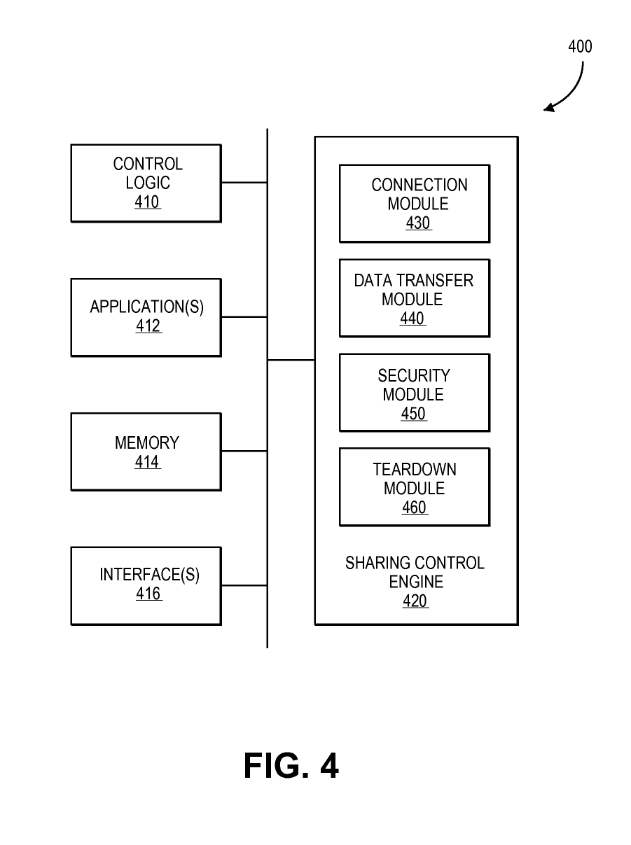

FIG. 4 is a block diagram of one embodiment of an agent that may be utilized to support sharing control functionality, for example, in a sharing control device as described above. The functionality of sharing control agent 400 may be provided as part of an independent sharing control device or as part of another device (e.g., smart phone, tablet, laser pointer, microphone).

Sharing control agent 400 includes control logic 410, which implements logical functional control to direct operation of sharing control agent 400, and/or hardware associated with directing operation of sharing control 400. In one embodiment, sharing control agent 410 will interpret user intent based on the device to which current connection is made and/or input from interfaces 414 (Button press, lighting condition, temperature etc. . . . ). Logic may be hardware logic circuits and/or software routines. In one embodiment, sharing control agent 400 includes one or more applications 412, which represent code sequence and/or programs that provide instructions to control logic 410.

Sharing control agent 400 includes memory 414, which represents a memory device and/or access to a memory resource for storing data and/or instructions. Memory 414 may include memory local to sharing control agent 400, as well as, or alternatively, including memory of the host system on which sharing control agent 400 resides. In one embodiment, sharing control agent 400 also includes one or more interfaces 416, which represent access interfaces to/from (an input/output interface) sharing control agent 400 with regard to entities (electronic or human) external to sharing control agent 400.

Sharing control agent 400 also includes sharing control engine 420, which represents one or more functions or modules that enable sharing control agent 400 to provide the sharing control services as described above. The example of FIG. 4 provides several modules that may be included in sharing control engine 420; however, different and/or additional modules may also be included. Example modules that may be involved in providing the sharing control functionality include connection module 430, data transfer module 440, security module 450, and teardown module 460. Each of these modules may further include other sub-modules to provide other functions. As used herein, a module refers to routine, a subsystem, logic circuit, microcode, etc., whether implemented in hardware, software, firmware or some combination thereof.

Connection module 430 provides the functionality to manage connections with shared resources and with source devices. In one embodiment, connection module 430 provides communication protocols and direction to cause the communications described herein to occur.

Data transfer module 440 provides the functionality to cause data to be transferred between devices as described herein. Data transfer module 440 may create the initiate and/or otherwise cause data to be transferred between devices (e.g., sharing control device to shared resource, sharing control device to source device, source device to shared resource). Various known transport mechanisms and formats can be used.

Security module 450 provides encryption services as necessary. Any encryption protocols/schemes known in the art may be supported. In one embodiment, security module 450 determines whether or not communications should be encrypted. Security module 450 may provide additional functionality, for example, specifics about security protocols and/or transmission/generation of cryptographic keys. In embodiments not utilizing encryption, security module 450 may be absent from sharing control engine 420.

Teardown module 460 manages teardown of connections between devices. In one embodiment, teardown module 460 includes a timer or other mechanism to determine whether a connection has expired. In alternate embodiments, teardown module 460 may cause the teardown to occur in response to input from one of the other modules of sharing control engine 420.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A resource sharing control device comprising:
memory to store data to be used for controlling sharing of a shared resource;
control circuitry coupled with the memory, the control circuitry to operate to control sharing of the shared resource, wherein the control circuitry operates to cause a source device to be paired with the shared resource based on a physical proximity of the resource sharing control device, wherein the resource sharing control device is external to the source device and the shared resource; and
circuitry to transmit data and circuitry to receive data, coupled with the control circuitry to facilitate transmission of data between the shared resource and the source device.

2. The resource sharing control device of claim 1, wherein the circuitry to transmit data and the circuitry to receive data are configured to communicate with the shared resource and the source device via a short-range wireless protocol.

3. The resource sharing control device of claim 2, wherein the short-range wireless protocol comprises one of: a Bluetooth-compliant protocol, a Zigbee-compliant protocol, a radio frequency identifier (RFID)-compliant protocol, a near field communication (NFC)-compliant protocol.

4. The resource sharing control device of claim 1, wherein the resource sharing control device is to communicate with the shared resource via a first communications protocol and the resource sharing control device is to cause the shared resource to communicate with the source device via a second communications protocol.

5. The resource sharing control device of claim 4, wherein the first communications protocol comprises a short-range wireless communications protocol and the second communications protocol comprises a local area network protocol.

6. The resource sharing control device of claim 1, wherein the resource sharing control device is to communicate with the source device via a first communications protocol and the resource sharing control device is to cause the shared resource to communicate with the source device via a second communications protocol.

7. The resource sharing control device of claim 6, wherein the first communications protocol comprises a short-range wireless communications protocol and the second communications protocol comprises a local area network protocol.

8. A method comprising:
establishing a connection between a sharing control device and a shared resource to control sharing of the shared resource with one or more source devices, the sharing control device being external from the shared resource and the one or more source devices;
initiating a data transfer between the sharing control device and the shared resource;
granting control of the shared resource to a selected source device from the one or more source devices in response to the sharing control device granting control of the shared resource to the selected source device.

9. The method of claim 8, wherein the shared resource and the sharing control device via a short-range wireless protocol.

10. The method of claim 9, wherein the short-range wireless protocol comprises one of: a Bluetooth-compliant protocol, a Zigbee-compliant protocol, a radio frequency identifier (RFID)-compliant protocol, a near field communication (NFC)-compliant protocol.

11. The method of claim 8, wherein the resource sharing control device is to communicate with the shared resource via a first communications protocol and the resource sharing control device is to cause the shared resource to communicate with the source device via a second communications protocol.

12. The method of claim 11, wherein the first communications protocol comprises a short-range wireless communications protocol and the second communications protocol comprises a local area network protocol.

13. The method of claim 8, wherein the resource sharing control device is to communicate with the source device via a first communications protocol and the resource sharing control device is to cause the shared resource to communicate with the source device via a second communications protocol.

14. The method of claim 13, wherein the first communications protocol comprises a short-range wireless communications protocol and the second communications protocol comprises a local area network protocol.

15. An article comprising a non-transitory computer-readable medium having stored thereon instructions that, when executed by one or more processors, cause the one or more processors to:
establish a connection between a sharing control device and a shared resource to control sharing of the shared resource with one or more source devices, the sharing control device being external from the shared resource and the one or more source devices;
initiate a data transfer between the sharing control device and the shared resource;
grant control of the shared resource to a selected source device from the one or more source devices in response to the sharing control device granting control of the shared resource to the selected source device.

16. The article of claim 15, wherein the shared resource and the sharing control device via a short-range wireless protocol.

17. The article of claim 16, wherein the short-range wireless protocol comprises one of: a Bluetooth-compliant protocol, a Zigbee-compliant protocol, a radio frequency identifier (RFID)-compliant protocol, a near field communication (NFC)-compliant protocol.

18. The article of claim 15, wherein the resource sharing control device is to communicate with the shared resource via a first communications protocol and the resource sharing control device is to cause the shared resource to communicate with the source device via a second communications protocol.

19. The article of claim 18, wherein the first communications protocol comprises a short-range wireless communications protocol and the second communications protocol comprises a local area network protocol.

20. The article of claim 15, wherein the resource sharing control device is to communicate with the source device via a first communications protocol and the resource sharing control device is to cause the shared resource to communicate with the source device via a second communications protocol.

21. The article of claim 13, wherein the first communications protocol comprises a short-range wireless communications protocol and the second communications protocol comprises a local area network protocol.
